(19) United States
(12) Patent Application Publication
(10) Pub. No.: US 2024/0104862 A1
(43) Pub. Date: Mar. 28, 2024

(54) SPATIALLY AWARE PLAYBACK FOR EXTENDED REALITY CONTENT

(71) Applicant: Apple Ine., Cupertino, CA (US)

(72) Inventors: Gregory Lutter, Boulder Creek, CA (US); Anna L. Brewer, Santa Barbara, CA (US); Devin W. Chalmers, Oakland, CA (US); Elena J. Nattinger, Menlo Park, CA (US)

(21) Appl. No.: 18/370,747

(22) Filed: Sep. 20, 2023

Related U.S. Application Data
(60) Provisional application No. 63/409,561, filed on Sep. 23, 2022.

(51) Int. Cl. G06T 19/00; G06T 7/70

(52) U.S. Cl. CPC G06T 19/006; G06T 7/70

(57) ABSTRACT

Videos are presented in an extended reality environment in a spatially aware manner such that a position of each frame of the video in the extended reality environment is based on one or more of a position, orientation, and field of view of a camera that captured the video.

### CROSS-REFERENCE TO RELATED APPLICATION(S)

This application is a nonprovisional patent application of and claims the benefit of U.S. Provisional Patent Application No. 63/409,561, filed Sep. 23, 2022 and titled “Spatially Aware Playback for Extended Reality Content,” the disclosure of which is hereby incorporated herein by reference in its entirety.

### TECHNICAL FIELD

Embodiments described herein relate to playback of content in an extended reality environment.

### BACKGROUND

Extended reality provides an immersive user experience that shows promise for both entertainment and productivity applications. As extended reality continues to rise in popularity, there is a demand for new ways of presenting content (e.g., images, videos, etc.) in an extended reality environment that feel natural and engaging to users. Specifically, it is desirable to present content in an extended reality environment to improve perceived realism and avoid unpleasant or disruptive aspects thereof.

### SUMMARY

Embodiments described herein relate to presentation of content in an extended reality environment. In one embodiment, an electronic device may include a display and a processor communicably coupled to the display. The processor may be configured to obtain a video of a scene. The video of the scene may include a plurality of frames, each associated with corresponding scene position information indicating an orientation of a camera during capture of the frame relative to a fixed view point. For each frame of the plurality of frames, the processor may be configured to determine a location for the frame in an extended reality environment based on the corresponding scene position information and, in accordance with a determination that at least a portion of the frame is within a displayed portion of the extended reality environment, present the frame at the location in the extended reality environment.

In one embodiment, the processor may be further configured to generate contextual content associated with the video. Generating the contextual content may include, for each frame of the video, selecting one or more contextual frames other than the frame, generating contextual content from the one or more contextual frames, and, in accordance with a determination that at least a portion of the contextual content is within the displayed portion of the extended reality environment, present the contextual content in the extended reality environment. The contextual content may be presented at one or more contextual locations in the extended reality environment selected using the corresponding scene position information from the one or more contextual frames. The contextual frames may comprise one or more frames preceding the current frame, or all of the frames of the video. Generating the contextual content may comprise adjusting one or more image characteristics of the one or more contextual frames.

In one embodiment, generating the contextual content may comprise, for each contextual frame of the one or more contextual frames, adjusting one or more image characteristics of the contextual frame based on a temporal relationship between the contextual frame and the frame. In one embodiment, generating the contextual content may comprise, for each contextual frame of the one or more contextual frames, adjusting one or more image characteristics of the contextual frame based on the corresponding scene position information for the contextual frame.

In one embodiment, generating the contextual content may comprise analyzing the one or more contextual frames and the corresponding scene position information to differentiate portions of each of the one or more contextual frames changing due to movement of a camera recording the video and portions of each of the one or more contextual frames due to movement of one or more subjects in the one or more contextual frames. The contextual content may then be generated based on a difference between the portions of each of the one or more contextual frames changing due to movement of the camera and the portions of each of the one or more contextual frames changing due to movement of one or more subjects in the one or more contextual frames.

In one embodiment, the electronic device may further include a motion tracking system communicably coupled to the processor. The processor may be further configured to determine the displayed portion of the extended reality environment based on motion information from the motion tracking system, and, in accordance with a determination that at least a portion of the frame is not within the displayed portion of the extended reality environment, present an indicator in the displayed portion of the extended reality environment. The indicator may provide a direction of the current frame of the video in the extended reality environment with respect to a location of the indicator in the extended reality environment.

In one embodiment, a method for presenting a video of a scene in an extended reality environment may include generating the extended reality environment and obtaining a video of a scene. The video may include a plurality of frames, each associated with corresponding scene position information describing an orientation of a camera during capture of the frame relative to a fixed point of view. For each frame of the video, a location may be determined for the frame in the extended reality environment based on the corresponding scene position information. In accordance with a determination that at least a portion of the frame is within a displayed portion of the extended reality environment, the frame may be presented at the location in the extended reality environment.

In one embodiment, the method further includes generating contextual content associated with the video. Generating the contextual content may include, for each frame of the video, selecting one or more contextual frames other than the frame, generating contextual content from the one or more contextual frames, and, in accordance with a determination that at least a portion of the contextual content is within the displayed portion of the extended reality environment, presenting the contextual content in the extended reality environment. The contextual content may be generated at one or more contextual locations in the extended reality environment selected using the corresponding scene position information from the one or more contextual frames. The contextual frames may comprise one or more frames preceding the current frame, or all of the frames of the video. Generating the contextual content may comprise adjusting one or more image characteristics of the one or more contextual frames.

In one embodiment, generating the contextual content may comprise, for each contextual frame of the one or more contextual frames, adjusting one or more image characteristics of the contextual frame based on a temporal relationship between the contextual frame and the frame. In one embodiment, generating the contextual content may comprise, for each contextual frame of the one or more contextual frames, adjusting one or more image characteristics of the contextual frame based on the corresponding scene position information for the contextual frame.

In one embodiment, generating the contextual content may comprise analyzing the one or more contextual frames and the corresponding scene position information to differentiate portions of each of the one or more contextual frames changing due to movement of a camera recording the video and portions of each of the one or more contextual frames due to movement of one or more subjects in the one or more contextual frames. The contextual content may then be generated based on a difference between the portions of each of the one or more contextual frames changing due to movement of the camera and the portions of each of the one or more contextual frames changing due to movement of one or more subjects in the one or more contextual frames.

In one embodiment, the method further includes receiving motion information from a motion tracking system, determining the displayed portion of the extended reality environment based on motion information from the motion tracking system, and, in accordance with a determination that at least a portion of the frame is not within the displayed portion of the extended reality environment, rendering an indicator in the displayed portion of the extended reality environment. The indicator may provide a direction of the current frame of the video in the extended reality environment with respect to a location of the indicator in the extended reality environment.

In one embodiment, a method for presenting a video including a plurality of frames in an extended reality environment includes, for one or more frames of the plurality of frames, selecting one or more additional frames, generating contextual content from the one or more additional frames, and concurrently presenting the frame and the contextual content in the extended reality environment.

In one embodiment, the contextual content may be generated at one or more contextual locations in the extended reality environment selected using the corresponding scene position information from the one or more contextual frames. The one or more additional frames may comprise one or more frames preceding the current frame. The one or more additional frames may comprise all frames of the video. Generating the contextual content may comprise adjusting one or more image characteristics of the one or more additional frames.

In one embodiment, generating the contextual content may comprise, for each additional frame of the one or more additional frames, adjusting one or more image characteristics of the additional frame based on a temporal relationship between the additional frame and the frame. In one embodiment, generating the contextual content may comprise, for each additional frame of the one or more additional frames, adjusting one or more image characteristics of the additional frame based on the corresponding scene position information for the additional frame.

In one embodiment, generating the contextual content may comprise analyzing the one or more contextual frames and the corresponding scene position information to differentiate portions of each of the one or more contextual frames changing due to movement of a camera recording the video and portions of each of the one or more contextual frames due to movement of one or more subjects in the one or more contextual frames. The contextual content may then be generated based on a difference between the portions of each of the one or more contextual frames changing due to movement of the camera and the portions of each of the one or more contextual frames changing due to movement of one or more subjects in the one or more contextual frames.

In one embodiment, concurrently presenting the frame and the contextual content is based on a determination that at least a portion of the frame is within a displayed portion of the extended reality environment.

In one embodiment, the method further includes receiving motion information from a motion tracking system, determining the displayed portion of the extended reality environment based on motion information from the motion tracking system, and, in accordance with a determination that at least a portion of the frame is not within the displayed portion of the extended reality environment, rendering an indicator in the displayed portion of the extended reality environment. The indicator may provide a direction of the current frame of the video in the extended reality environment with respect to a location of the indicator in the extended reality environment.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 is a block diagram illustrating an electronic device, such as described herein.

FIGS. 2A through 2F illustrate capture and presentation of a video in an extended reality environment, such as described herein.

FIGS. 3A and 3B illustrate presentation of a video in an extended reality environment, such as described herein.

FIG. 4 is a flowchart depicting example operations of a method of displaying a video in an extended reality environment, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to the presentation of content in an extended reality environment. As discussed herein, an extended reality environment refers to a computer generated environment, which may be presented to a user as a completely virtual environment (e.g., virtual reality) or as one or more virtual elements that enhance or alter one or more real world objects (e.g., augmented reality and/or mixed reality). While extended reality shows promise as a user interface due to the immersive nature thereof, presenting content in an extended reality environment in a way that improves realism while avoiding unpleasant or disruptive aspects (e.g., motion sickness, difficulty orienting within the environment, etc.) presents new challenges.

For example, presenting a video in an extended reality environment may present particular difficulties when that video is captured during camera motion. As a camera moves during video capture of a scene, different frames will capture different portions of the scene depending on the camera's orientation. For example, if the camera is part of a head-mounted device, a user rotating their head (and thereby the camera) during video capture will cause the captured video to include different portions of the scene. If this video is later presented at a fixed location in an extended reality environment, the changing viewpoint within the video may, depending on the amount and nature of the camera motion during capture, cause discomfort to the viewer.

Embodiments described herein include presenting a video in an extended reality environment in a spatially aware manner. Specifically, frames of the video may be presented at locations in the extended reality environment based on scene position information associated with each frame. The scene position information for a given frame includes a relative position of the frame relative to a fixed point of view (hereinafter the “scene point of view”), which represents the orientation of the camera when that frame was captured, and thereby, which portion of a scene was captured by that frame. Accordingly, if a camera is not moving during the capture of a first set of frames, each of these frames will have the same scene position information. Conversely, if the camera is moving (e.g., rotating) during the capture of a second set of frames, each of these frames will have different scene position information.

When presenting the video in an extended reality environment, the video may be presented relative to a fixed point of view (hereinafter the “presentation point of view”) in the extended reality environment. The spatial position information for each frame may be used to select a presentation location of the frame relative to the presentation point of view. Accordingly, frames that captured different portions of a scene will be presented at different locations within the extended reality environment.

The scene position information may specify the position of each frame relative to the scene point of view, and may further specify the orientation of each frame relative to the scene point of view, such that the scene positioning information is relative to some fixed point in space. For example, the scene position information may include spherical coordinates of the camera at a fixed radius (e.g., an inclination (i.e., polar angle) and azimuth (i.e., azimuthal angle) of the camera for each frame of the video), where the fixed point of view defines the origin of the spherical coordinate system. In some of these instances, each frame is considered to be oriented orthogonally to the origin of the spherical coordinate system.

The scene position information may be captured by the device including the camera or by another device during recording of the video. The location of each frame of the video in the extended reality environment may be chosen to represent movement of the camera during capture of the video. For example, each frame of the video may be placed at spherical coordinates in the extended reality environment such that an inclination and azimuth of the frame is the same as or otherwise related to the inclination and azimuth of the camera during capture of the frame. Additionally, the presentation point of view may be selected at a position corresponding to a position of a user in the extended reality environment (e.g., which represents an origin of the spherical coordinate system in the extended reality environment). Presenting the frames in this manner may allow a user to feel as if they are viewing the video from the perspective of the camera, which may enhance the realism of the viewing experience.

In addition to spatially aware playback of the frames of the video, contextual content may also be presented along with these frames. The contextual content may help the user orient to the content and further enhance realism of the viewing experience. The contextual content may be based on one or more contextual frames other than a currently presented frame. The contextual content may show portions of a scene captured by the video that are outside of the currently presented frame.

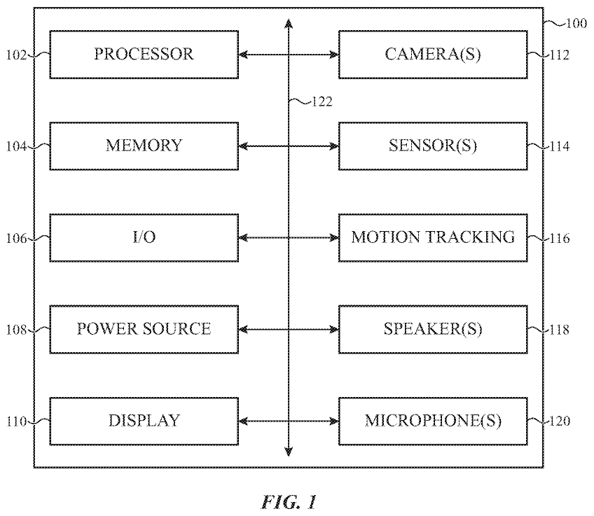

FIG. 1 is a block diagram illustrating an electronic device 100 for generating and/or presenting an extended reality environment to a user according to one embodiment of the present disclosure. The electronic device 100 may include a processor 102, a memory 104, an input/output (I/O) mechanism 106, a power source 108, a display 110, one or more cameras 112, one or more sensors 114, a motion tracking system 116, one or more speakers 118, and one or more microphones 120. The processor 102, the memory 104, the I/O mechanism 106, the power source 108, the display 110, the one or more cameras 112, the one or more sensors 114, the motion tracking system 116, the one or more speakers 118, and the one or more microphones 120 may be communicably coupled via a bus 122.

The processor 102 may be configured to execute instructions stored in the memory 104 in order to provide some or all of the functionality of the electronic device 100, such as the functionality discussed herein. The processor 102 may be implemented as any electronic device capable of processing, receiving, or transmitting data or instructions, whether such data or instructions is in the form of software or firmware or otherwise encoded. For example, the processor 102 may include a microprocessor, a central processing unit (CPU), an application-specific integrated circuit (ASIC), a digital signal processor (DSP), a controller, or a combination of such devices. As discussed herein, the term processor is meant to encompass a single processing unit, multiple processors, multiple processing units, or other suitably configured computing element or elements.

In some embodiments, the components of the electronic device 100 may be controlled by multiple processors. For example, select components of the electronic device 100 such as the one or more sensors 114 may be controlled by a first processor while other components of the electronic device 100 (e.g., the display 110) may be controlled by a second processor, where the first and second processor may or may not be in communication with each other.

The memory 104 may store electronic data that can be used by the electronic device 100. For example, the memory 104 may store instructions, which, when executed by the processor 102 provide the functionality of the electronic device 100 described herein. The memory 104 may further store electrical data or content such as, for example, audio and video files, documents and applications, device settings and user preferences, timing signals, control signals, and data structures and databases. The memory 104 may include any type of memory. By way of example only, the memory 104 may include random access memory (RAM), read-only memory (ROM), flash memory, removeable memory, and/or other types of storage elements, or a combination of such memory types.

The I/O mechanism 106 may transmit or receive data from a user or another electronic device. The I/O mechanism 106 may include the display 110, a touch sensing input surface, one or more buttons, the one or more cameras 112, the one or more speakers 118, the one or more microphones 120, one or more ports, a keyboard, or the like. Additionally or alternatively, the I/O mechanism 106 may transmit electronic signals via a communications interface, such as a wireless, wired, and/or optical communications interface. Examples of wireless and wired communications interfaces include, but are not limited to, cellular and Wi-Fi communications interfaces.

The power source 108 may be any device capable of providing energy to the electronic device 100. For example, the power source 108 may include one or more batteries or rechargeable batteries. Additionally or alternatively, the power source 108 may include a power connector or power cord that connects the electronic device 100 to another power source, such as a wall outlet.

The display 110 may provide a user interface to a user of the electronic device 100. In some embodiments, the display 110 may show a portion of an extended reality environment to a user. The display 110 may be a single display or include two or more displays. For example, the display 110 may include a display for each eye of a user. The display 110 may include any type of display, including a liquid crystal display (LCD), an organic light-emitting diode (OLED) display, or any other type of display.

The one or more cameras 112 may be positioned and oriented on the electronic device 100 to capture images of an environment in which the electronic device 100 is located. In some embodiments, these images may be used to provide an extended reality experience to a user. For example, the one or more cameras 112 may be used to track objects in the environment and/or for generating a portion of an extended reality environment (e.g., by recreating of a portion of the environment within the extended reality environment). The one or more cameras 112 may be any suitable type of camera. In various embodiments, the electronic device 100 may include one, two, four, or any number of cameras. In some embodiments, some of the one or more cameras 112 may be positioned and oriented on the electronic device 100 to capture images of the user. For example, the images may be used to track a portion of the user's body, such as their eyes, mouth, cheek, arms, torso, or legs.

The one or more sensors 114 may capture additional information about the environment in which the electronic device 100 is located and/or a user of the electronic device 100. The one or more sensors 114 may be configured to sense one or more types of parameters, including but not limited to: vibration, light, touch, force, temperature, movement, relative motion, biometric data (e.g., biological parameters of a user), air quality, proximity, or position. By way of example, the one or more sensors 114 may include one or more optical sensors, a temperature sensor, a position sensor, an accelerometer, a pressure sensor, a gyroscope, a health monitoring sensor, and/or an air quality sensor. Additionally, the one or more sensors 114 may utilize any suitable sensing technology including, but not limited to, interferometric, magnetic, capacitive, ultrasonic, resistive, optical, acoustic, piezoelectric, or thermal technologies.

The motion tracking system 116 may provide motion tracking information about the electronic device 100. For example, the motion tracking system 116 may provide a position and orientation of the electronic device 100 (e.g., an inclination and azimuth of the electronic device 100) that is either absolute or relative. The motion tracking system 116 may utilize any of the one or more sensors 114 to do so, or may include separate sensors for providing the motion tracking information. The motion tracking system 116 may also utilize any of the one or more cameras 112 for providing the motion tracking information, or may include one or more separate cameras for doing so.

The one or more speakers 118 may be configured to output sounds to a user of the electronic device 100. The one or more speakers 118 may be any type of speakers in any form factor. For example, the one or more speakers 118 may be configured to go on or in the ears of a user, or may be bone conducting speakers, extra-aural speakers, or the like. Further, the one or more speakers 118 may be configured to playback binaural audio to the user. The one or more microphones 120 may be positioned and oriented on the electronic device 100 to sense sound provided from the surrounding environment and/or the user. The one or more microphones 120 may be any suitable type of microphones, and may be configured to enable the electronic device 100 to record binaural sound.

The electronic device 100 may be any device that enable a user to sense and/or interact with an extended reality environment. For example, the electronic device 100 may be a projection system, a heads-up display (HUD), a vehicle window or other window having integrated display capabilities, a smartphone, a tablet, and/or a computer. In one embodiment, the electronic device 100 may be a head-mounted device. Accordingly, the electronic device 100 may include a housing configured to be provided on or over a portion of a face of a user, and one or more straps or supports for holding the electronic device 100 in place when worn by the user. Further, the electronic device 100 may be configured to completely obscure the surrounding environment from the user (e.g., using an opaque display to provide a VR experience), or to allow the user to view both the surrounding environment with virtual content overlaid thereon (e.g., using a semi-transparent display to provide an AR experience), and may allow switching between the two. However, the principles of the present disclosure apply to electronic devices having any form factor.

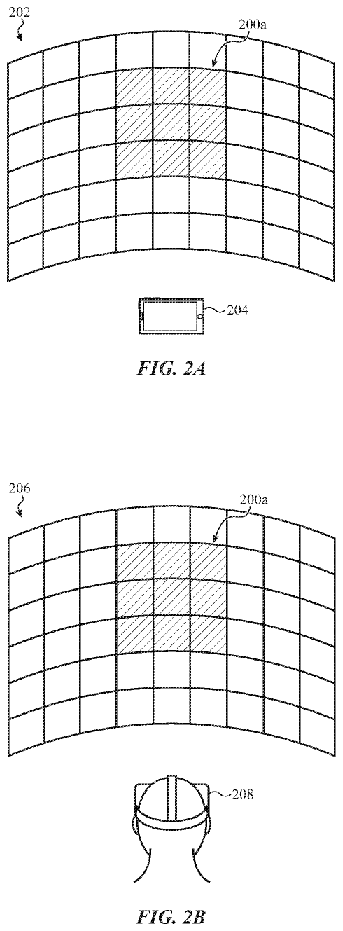

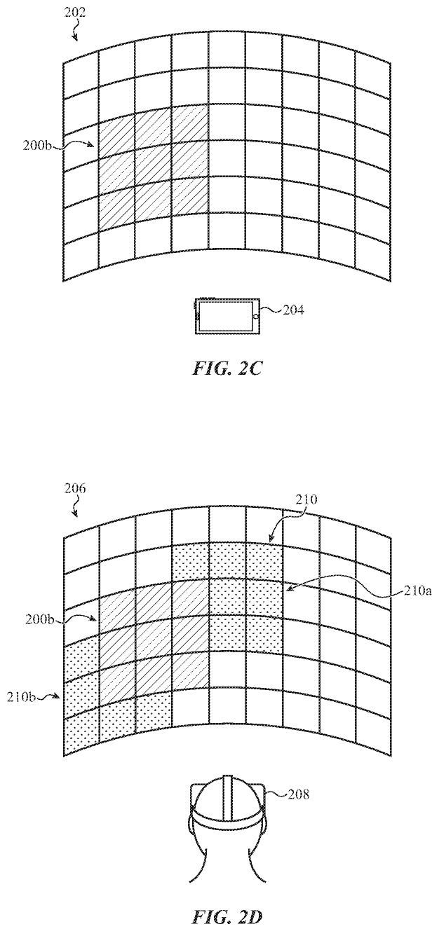

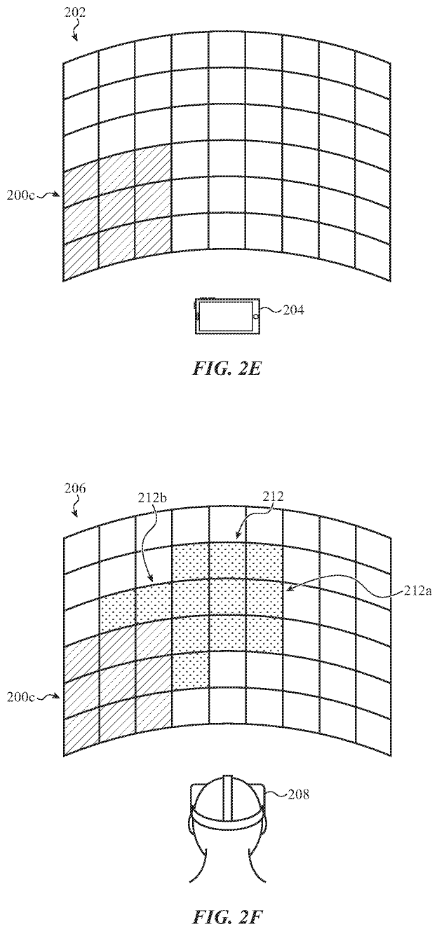

FIGS. 2A through 2F illustrate spatially aware playback of a video in an extended reality environment. Specifically, FIGS. 2A, 2C, and 2E illustrate capture of a video for playback in an extended reality environment, while FIGS. 2B, 2D, and 2F illustrate playback of the same video in an extended reality environment. FIG. 2A shows a first frame 200a of a scene 202 being captured by a camera 204. For purposes of illustration, the scene 202 is shown as a grid. The portion of the scene 202 captured in the first frame 200a is illustrated by hatching in the grid, and may correspond to a field of view of the camera 204 during capture of the first frame 200a. Simultaneously with capturing the first frame 200a of the scene 202, the camera 204 (or a separate device) may also capture scene position information describing, for example, one or more of a position, orientation, and zoom level of the camera 204 while capturing the first frame 200a. For example, an inclination and an azimuth of the camera 204 with respect to a fixed view point (i.e., the scene point of view) may be captured simultaneously with the first frame 200a. The scene position information may be stored for later use when playing back the video.

FIG. 2B shows playback of the first frame 200a of the scene 202 in an extended reality environment by a head-mounted device 208. For purposes of illustration, the portion 206 of the extended reality environment being displayed by the head-mounted device 208 is shown as a grid. The first frame 200a is shown at a first location in the extended reality environment, which is illustrated by hatching in the grid. The first location is chosen based on the scene position information captured during recording of the first frame 200a as discussed above. As shown, the first frame 200a is positioned at a location in the extended reality environment that corresponds to the portion of the scene 202 captured by the camera 204. That is, a position, orientation, and size of the first frame 200a in the extended reality environment reflects or is otherwise related to a position, orientation, and zoom level of the camera 204 during capture of the first frame 200a. In one example, the scene position information associated with the first frame 200a includes an inclination and an azimuth of the camera 204 relative to the scene point during capture of the first frame 200a. The first location may be at the same or a related inclination and azimuth with respect to a corresponding point of view in the extended reality environment (i.e., the presentation point of view), which may correspond to a viewing location (e.g., a center location or location of a user) in the extended reality environment.

FIG. 2C shows a second frame 200b of the scene 202 being captured by the camera 204. The portion of the scene 202 captured in the second frame 200b is similarly illustrated by hatching in the grid. As shown, the portion of the scene 202 captured in the second frame 200b is moved slightly with respect to the portion of the scene 202 captured in the first frame 200a, which may be due to movement (e.g., position and/or orientation) of the camera 204 by a user thereof. FIG. 2D shows playback of the second frame 200b in the extended reality environment. The second frame 200b is positioned at a second location in the extended reality environment, which is similarly illustrated by hatching in the grid. As shown, the second location is moved with respect to the first location to reflect movement of the camera 204 between the first frame 200a and second frame 200b. Following the example described with respect to FIG. 2B, the scene position information associated with the second frame 200a also includes an inclination and azimuth of the camera 204 relative to the scene point of view during capture of the second frame 200b. The inclination and azimuth may change between the first and second frames due to movement of the camera 204. The second location may be at the same or a related inclination and azimuth with respect to the presentation point of view in the extended reality environment.

By presenting frames of video captured by the camera 204 at locations in the extended reality environment that reflect changes in the position, orientation, and/or field of view of the camera 204 capturing the video, a user may experience a more realistic viewing experience of the video, allowing them to follow the camera movement. This is referred to herein as spatially aware playback. In some embodiments, if the head mounted device 208 is translated in the surrounding environment (e.g., due to a user of the device walking forward), the portion 206 of the extended reality environment may be presented so that the second frame 200b is maintained at the same relative distance from the user in the extended reality environment.

To further enhance spatially aware playback of the video, contextual content 210 may be generated in addition to the current frame of the video (which, in FIG. 2D, is the second frame). The contextual content 210 is illustrated in FIG. 2D as a dotted portion of the grid. As will be discussed in further detail, the contextual content 210 may be generated from or otherwise comprise frames of the video other than the current frame. In the current example, the contextual content 210 includes a first region 210a generated from all or a portion of the first frame 200a, on which the second frame 200b is overlaid (in cases in which the second frame 200b overlaps with the first frame 200a) or is otherwise presented simultaneously with. Accordingly, the location of the contextual content 210 in the extended reality environment includes the location of the first frame 200a shown in FIG. 2B. One or more image characteristics of the first frame 200a may be adjusted to provide the first region 210a of the contextual content 210. For example, one or more of a saturation, a brightness, a sharpness, or any other image characteristic of the first frame 200a may be adjusted to provide the first region 210a of the contextual content 210. In one embodiment, the first frame 200a continues to be displayed, but is intentionally blurred, while the second frame 200b is reproduced. The contextual content 210 may aid in orienting a user to the current frame, and also give the user a better idea of a surrounding context of the video. This may further enhance the realistic viewing experience of the video.

In addition to the first region 210a, the contextual content 210 may include a second region 210b generated from all or a portion of a third frame 200c, which is ahead of (i.e., captured after) the second frame in the video. The second frame 200b may similarly be overlaid on the second region 210b (in cases in which the second frame 200b overlaps the third frame 200c) or is otherwise simultaneously presented with the second region 210b. One or more image characteristics of the third frame 200c may be adjusted to provide the second region 210b of the contextual content 210. For example, one or more of a saturation, a brightness, a sharpness, or any other image characteristic of the third frame 200c may be adjusted to provide the second region 210b of the contextual content 210. In general, the contextual content 210 may include or be generated from any number of frames of the video other than the current frame (the second frame 200b in FIG. 2D). For example, the contextual content 210 may include or be generated from the first frame 200a only, the third frame 200c only, or any other subset of frames of the video, including every frame of the video (in which case a representation of the entirety of the scene 202 captured by the camera 204 is generated as the contextual content 210 and frames of the video or overlaid on or otherwise simultaneously presented with the contextual content 210). Further, the contextual content 210 may be presented at a number of contextual locations in the extended reality environment selected based on the scene position information associated with the contextual frames (e.g., the contextual content generated from the first frame 200a is shown in the first location, the contextual content generated from the third frame 200c is shown in a third location as discussed below).

Additionally, while some contextual content may be generated by modifying image data of the video frames (e.g., adjusting a saturation, a brightness, a sharpness of image data from a video frame), this contextual content may be limited to locations of these video frames. In some instances, some of the contextual content may be synthetically generated. In these instances, one or more frames of the video may be analyzed (e.g., using a machine learning algorithm) to generate synthetic image content. By using synthetic image content, contextual content may be presented at a wider range of locations around the current frame. Accordingly, in some variations the contextual content may include both modified image data and synthetic image data (e.g., at different locations within the user's field of view), while in other instances the contextual content may include only modified image data or only synthetic image data.

FIG. 2E shows the third frame 200c of the scene 202 being captured by the camera 204. The portion of the scene 202 captured in the third frame 200c is similarly illustrated by hatching in the grid. As shown, the portion of the scene captured in the third frame 200c is moved slightly with respect to the portion of the frame captured in the second frame 200b, which may be due to movement of the camera 204 by a user thereof. FIG. 2F shows playback of the third frame 200c in the extended reality environment. The third frame 200c is placed at a third location in the extended reality environment, which is similarly illustrated by hatching in the grid. As shown, the third location is moved with respect to the second location to reflect movement of the camera between the second frame 200b and the third frame 200c. Further, updated contextual content 212, which is illustrated by the dotted portion of the grid that includes the area previously occupied by both the first frame 200a and the second frame 200b, may be generated simultaneously with the third frame 200c. This is to illustrate that contextual content as described herein may be generated based on more than one previous frames of the video. While not shown, the updated contextual content 212 may be further expanded to include additional area from future frames of the video (e.g., a fourth frame of the video, a fifth frame of the video, etc.), which may be outside of the displayed portion 206 of the extended reality environment.

Similar to the discussion above with respect to FIG. 2D, the updated contextual content 212 may include a first region 212a generated from all or a portion of the first frame 200a and a second region 212b generated from all or a portion of the second frame 200b. Image characteristics of the first frame 200a and the second frame 200b may be adjusted to provide the first region 212a and the second region 212b, respectively. In one embodiment, image characteristics of the first frame 200a and the second frame 200b may be adjusted independently. Following the example given above with respect to FIG. 2D, the portion of the first frame 200a not replaced by the second frame 200b may remain displayed, but blurred even further, and the portion of the second frame 200b not replaced by the third frame 200c may remain displayed and blurred less than the first frame 200a, while the third frame 200c is reproduced. In general, generating the contextual content may include adjusting one or more image characteristics of one or more contextual frames based on a temporal relationship between the contextual frame and a current frame (e.g., the further in time the contextual frame is from the current frame, the more blurry or faded it is), scene position information associated with the contextual frame (e.g., large changes in camera position between frames may be indicated by a higher amount of blur being applied to these contextual frames), or any other information.

To enable spatially aware playback of a video, a video may be recorded along with scene position information, which describes one or more of a position, orientation, and field of view of the camera during capture of the scene. The playback device may use this scene position information to present the frames of the video in corresponding locations in an extended reality environment. The scene position information may be pre-processed with the video to generate a spatially aware extended reality content item describing the location of each frame of the video in the extended reality environment, or may be processed in real time during playback to provide the spatially aware playback experience.

While the camera 204 is illustrated as a mobile phone, the camera 204 may be any type of device capable of capturing video and, in some embodiments, associated scene position information. Further, while playback of the video in the extended reality environment is illustrated with respect to the head-mounted device 208, any suitable type of device may be used to present the extended reality environment to a user.

While the portions of the scene 202 captured in each frame 200 of the video and the locations of frames 200 in the extended reality environment are shown having the same fixed point of view (i.e., the scene point of view is the same as the presentation point of view) in FIGS. 2A through 2F, the present disclosure contemplates any relative orientation between the scene point of view and the presentation point of view. For example, the presentation point of view may be selected based on the orientation the head-mounted device 208 when playback is initiated. This may be used to ensure that the first frame of the video is within a user's field of view, regardless of where the user is looking when head-mounted device 208 initiates playback.

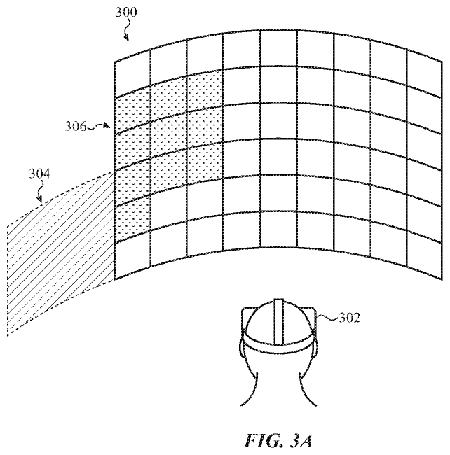

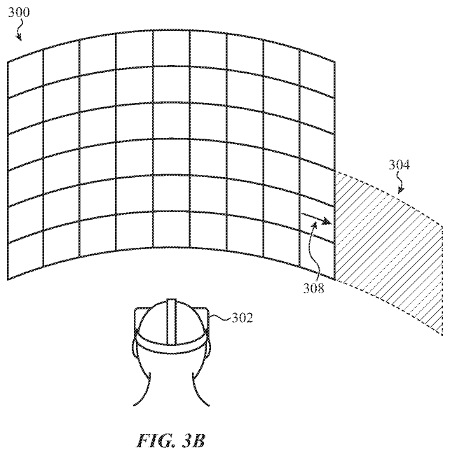

As discussed with respect to FIGS. 2B, 2D, and 2F, the grid represents the portion of the extended reality environment currently displayed to the user. As the user moves their head, the head-mounted device 208 may track this movement and display a different portion of the extended reality environment. In some situations, a current frame of video may be positioned at a location within the extended reality environment that is not within the portion currently displayed to the user (i.e., the field of view of the user). This is illustrated in FIG. 3A, which similarly shows a grid representing a portion of an extended reality environment currently displayed to the user at a head-mounted device 302. A hatched area outside the portion of the extended reality environment currently displayed to the user represents a current frame 304 of a video being played in the extended reality environment. As a result, it may be possible that some frames (or portions thereof) are not displayed to a user during playback of the video, depending on positioning of the frames relative to the field of view of the user. Even if the current frame is positioned outside of the user's field of view, some or all of the contextual content associated with that frame may still be displayed to the user. In the example shown in FIG. 3A, contextual content 306, represented by the dotted portion of the grid, is still within the portion of the extended reality environment currently displayed to the user. Accordingly, the contextual content may orient the user to the current frame, allowing them to easily locate and reorient towards the current frame in the extended reality environment.

However, in some situations both the current frame 304 of the video and the contextual content 306 associated with the current frame 304 may be located outside the displayed portion 300 of the extended reality environment currently displayed to the user. Such a scenario is shown in FIG. 3B, which again illustrates the current frame 304 of a playing video as a hatched area outside of the portion of the extended reality environment currently displayed to the user. In this situation, it may be difficult for a user to know where to look to find the video within the extended reality environment. an indicator 308 orienting the user towards the current frame of the video may be generated in the extended reality environment. The indicator 308 is shown as an arrow in FIG. 3B pointing towards the current frame of the video. However, any indicator 308, such as a dot, textual instructions, or otherwise, may similarly be used. The indicator 308 may disappear when the user moves their head such that the displayed portion 300 of the extended reality environment includes one or more of the contextual content 306 and the current frame 304 of the video.

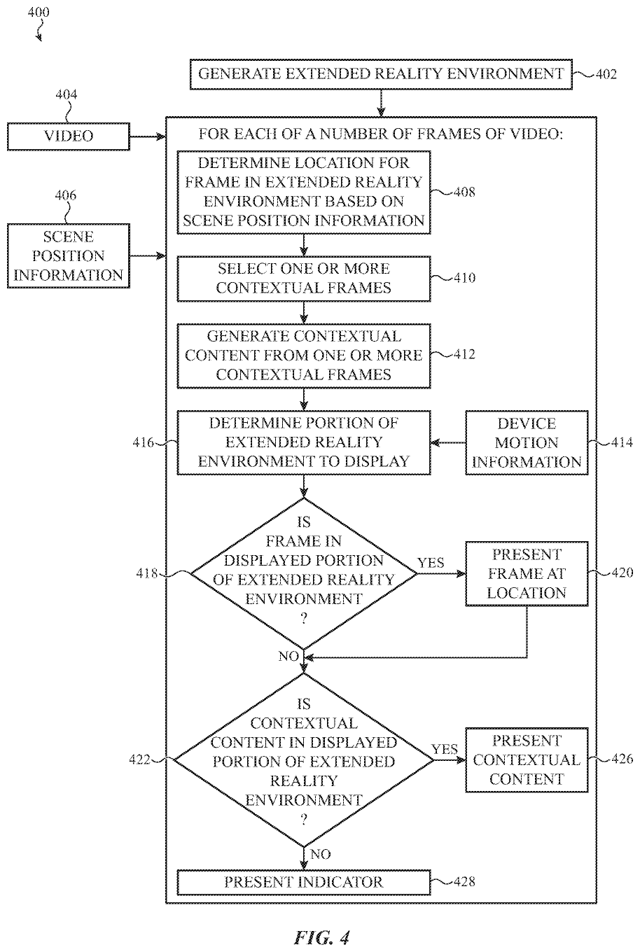

FIG. 4 is a flow diagram illustrating a method 400 for displaying a video of a scene in an extended reality environment according to one embodiment of the present disclosure. An extended reality environment is generated (block 402). Generating the extended reality environment may include constructing a representation of the extended reality environment in such a way that at least a portion of the extended reality environment can be displayed to a user. For example, generating the extended reality environment may include constructing a representation of the extended reality environment in a memory of an electronic device. Generating the extended reality environment may be performed in real time during playback of a video as discussed herein, or may occur before playback of a video. The extended reality environment may be generated locally by an electronic device presenting the video to a user, or may be accomplished by one or more processing resources remote to the electronic device (e.g., one or more processing resources on a remote server).

A video and scene position information associated with the frames of the video are accessed (blocks 404 and 406, respectively). The video includes a number of frames, and each frame is associated with corresponding scene position information. The video and scene position information may be provided separately or together. The scene position information describes one or more of a position, an orientation, and a zoom of a camera that captured the video during recording of the video from a fixed point of view. In one embodiment, the scene position information includes an inclination and azimuth of the camera that captured the video during recording of the video in a spherical coordinate system having a fixed radius and an origin at the fixed point of view. Accessing the video and scene position information may comprise retrieving the video and scene position information from a memory or receiving the video and scene position information from a remote device, for example.

The remaining blocks of the method 400 may be performed for all or a subset of the frames of the video, and describe operations that may be performed for each of the frames or subset of frames. In the discussion that follows, “the frame” refers to the frame of the video currently being operated on by the method 400. A location for the frame in the extended reality environment may be determined based on the scene position information associated with the frame (e.g., relative to a fixed point of view in the extended reality environment as discussed previously) (block 408). Determining the location for the frame in the extended reality environment based on the scene position information may include analyzing the scene position information associated with the frame to select a location in the extended reality environment that reflects one or more of a position, an orientation, and/or field of view of the camera that captured the frame during recording of the video, and mapping the scene position information to a location in the extended reality environment (e.g., via any number of translations or mathematical operations). The location of the frame in the extended reality environment may include coordinates (e.g., a spherical coordinates describing a center of the frame), a size of the frame in the extended reality environment, and an orientation of the frame with respect to the user. In one embodiment, the scene position information includes an inclination and an azimuth of the camera that captured the video during capture of the current frame relative to a fixed view point. The location may be selected to have the same or a related inclination and azimuth relative to a viewing perspective in the extended reality environment. The location in the extended reality environment for each frame of the video may be determined in real time as the video plays (e.g., for a single frame of video as it is presented, for a number of frames of the video before they are presented in a buffered fashion), or the video may be pre-processed and locations in the extended reality environment determined for some or all frames of the video before playback. That is, block 408 may be performed simultaneously with playback of the video, or before playback of the video.

Optionally, contextual content may also be generated for the frame. To do this, one or more contextual frames of the video are selected (block 410). The contextual frames may comprise one more frames preceding the frame, one or more frames after the frame, or a combination thereof. The contextual frames may not include the frame. Any subset of the frames of the video may be used to generate the contextual content. In one embodiment, all of the frames of the video are selected as contextual frames. Contextual content is then generated from the contextual frames (block 412). Generating contextual content from the contextual frames may comprise adjusting one or more image characteristics of the contextual frames. For example, one or more of a saturation, a brightness, a sharpness, or any other image characteristic of the contextual frames may be adjusted. In one embodiment, generating contextual content from the contextual frames may comprise analyzing the contextual frames and corresponding scene position information to differentiate portions of the contextual frames changing due to movement of the camera recording the video and portions of the contextual frames changing due to movement of one or more subjects in the contextual frames. The contextual content may then be generated based on a difference between the portions of the contextual frames changing due to movement of the camera and the portions of the contextual frames changing due to movement of one or more subjects in the one or more contextual frames. The contextual content may be generated at one or more contextual locations in the extended reality environment, which are based on corresponding scene position information associated with the contextual frames. The contextual locations may be determined for each of the contextual frames as discussed above with respect to block 408. For example, for each contextual frame of the video selected, contextual content may be generated at a location in the extended reality environment corresponding to the scene position information. In the case that a subset of frames of the video or all of the frames of the video are selected as contextual frames, a representation of the entirety of the scene captured during the video may be generated in the extended reality environment. This may provide a user with a scope of the portion of the scene captured by the video. Frames of the video may be positioned over the contextual content (to the extent a current frame overlaps with the contextual content), as discussed below.

Notably, the generation of contextual content described in blocks 410 and 412 is optional. In some embodiments, blocks 410 and 412 may be performed only when at least a portion of the frame is within a displayed portion of the extended reality environment, and/or when the frame is positioned within the extended reality environment such that at least a portion of the contextual content would be positioned within the displayed portion of the extended reality environment. As discussed below, in some cases only a portion of the extended reality environment is displayed to the user (e.g., based on the head position of the user). If at least a portion of the frame is not within the displayed portion of the extended reality environment (e.g., if the user is not looking towards the frame in the extended reality environment), blocks 410 and 412 may be skipped to reduce processing resources. In some embodiments, if a portion of the contextual content is within the displayed portion of the extended reality environment, the contextual content may be generated, regardless of whether a portion of the frame is within the displayed portion of the extended reality environment. In some embodiments, blocks 410 and 412 may be skipped regardless of whether the location of the frame is within the portion of the extended reality environment displayed to a user. When generated, the contextual content may orient a user to a current frame of the video in the extended reality environment and enhance user immersion in playback of the video. In some embodiments, contextual content may be generated for all frames of the video simultaneously (e.g., in a pre-processing step), and therefore may occur separately from the blocks shown in FIG. 4 or in a different order than shown in FIG. 4.

Optionally, device motion information about an electronic device may be obtained (block 414). The device motion information may be provided from a motion tracking system, and may describe one or more of a position and an orientation of the electronic device. For example, the device motion information may include an inclination and an azimuth of the electronic device in a spherical coordinate system. A portion of the extended reality environment to display may be determined based on the device motion information (block 416). This enables a user to view different portions of the extended reality environment as they move their head.

A determination may be made whether all or a portion of the frame is within the displayed portion of the extended reality environment (block 418). This may include determining if the location for the frame in the extended reality environment is within the displayed portion of the extended reality environment, or if some area extending from the determined location for the frame in the extended reality environment is within the displayed portion of the extended reality environment. If all or a portion of the frame is within the displayed portion of the extended reality environment, the frame may be presented at the location in the extended reality environment (block 420). Presenting the frame at the location in the extended reality environment may include any steps necessary to render or otherwise display the frame within the extended reality environment.

Once the frame is presented at the location in the extended reality environment, or if it is determined that the frame is not in the displayed portion of the extended reality environment, a determination is made whether all or a portion of the contextual content is within the displayed portion of the environment (block 422). If all or a portion of the contextual content is within the displayed portion of the extended reality environment, the contextual content may be presented in the extended reality environment (block 426). The contextual content may be presented at one or more contextual locations in the extended reality environment selected using corresponding scene position information from the one or more contextual frames. That is, for each contextual frame, contextual content may be generated at a location for the contextual frame in the extended reality environment determined as discussed above with respect to block 408. The contextual content may be presented simultaneously with the frame (if the frame is presented). In some embodiments, the frame may be overlaid on the contextual content, if the frame overlaps with the contextual content. Presenting the contextual content may include any steps necessary to render or otherwise display the contextual content within the extended reality environment.

If all or a portion of the contextual content is not within the displayed portion of the extended reality environment, an indicator may be presented in the displayed portion of the extended reality environment (block 428). The indicator may be presented anywhere in the displayed portion of the extended reality environment. The indicator may orient a user to the frame and/or the contextual content in the extended reality environment. The indicator may be any graphical indicator (e.g., a dot, an arrow, textual instructions) that orients the user to the current frame and/or contextual content or otherwise informs the user that the frame and/or contextual content are not within the displayed portion of the extended reality environment. Presenting the indicator may include any steps necessary to render or otherwise display the indicator within the extended reality environment.

Notably, block 428 is optional, such that presenting the indicator may be omitted in some embodiments. Further, blocks 422 and 426 are also optional, and may be omitted in embodiments in which contextual content is not generated or otherwise presented. In such cases, if it is determined that all or a portion of the frame is not within the displayed portion of the extended reality environment, the indicator may be presented as discussed above. In cases where block 428 is also omitted, the method 400 may simply move to the next frame of the video, repeating the blocks described above.

The blocks of the method 400 may be accomplished at an electronic device (e.g., by a processor or processing resource of the electronic device, which is programmed by instructions stored in a memory of the device), or at any combination of an electronic device and one or more remote devices. For example, the extended reality environment may be generated, the locations for each frame of the video in the extended reality environment determined, and contextual content generated at a remote device, and frames of the video and/or contextual content may be presented at the electronic device.

These foregoing and other embodiments are discussed below with reference to FIGS. 1-4. However, those skilled in the art will readily appreciate that the detailed description given herein with respect to these figures is for explanation only and should not be construed as limiting.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

Principles of the present disclosure may be implemented as instances of purpose-configured software, and may be accessible, for example, via API as a request-response service, an event-driven service, or configured as a self-contained data processing service. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

What is claimed is:

1. An electronic device, comprising:
a display; and
a processor communicably coupled to the display and configured to:
obtain a video of a scene, wherein the video includes a plurality of frames, each associated with corresponding scene position information indicating an orientation of a camera during capture of the frame relative to a fixed view point;
for each frame of the plurality of frames:
determine a location for the frame in an extended reality environment based on the corresponding scene position information; and
in accordance with a determination that at least a portion of the frame is within a displayed portion of the extended reality environment, present the frame at the location in the extended reality environment.

2. The electronic device of claim 1, wherein the processor is further configured to generate contextual content associated with the video, comprising, for each frame of the plurality of frames:
selecting one or more contextual frames other than the frame;
generating the contextual content from the one or more contextual frames; and
in accordance with a determination that at least a portion of the contextual content is within the displayed portion of the extended reality environment, presenting the contextual content in the extended reality environment.

3. The electronic device of claim 2, wherein the contextual content is generated at one or more contextual locations in the extended reality environment selected using the corresponding scene position information from the one or more contextual frames.

4. The electronic device of claim 2, wherein the one or more contextual frames comprise one or more frames preceding the frame.

5. The electronic device of any of claim 2, further comprising generating the contextual content by adjusting one or more image characteristics of the one or more contextual frames.

6. The electronic device of claim 2, wherein generating the contextual content comprises, for each contextual frame of the one or more contextual frames, adjusting one or more image characteristics of the contextual frame based on a temporal relationship between the contextual frame and the frame.

7. The electronic device of claim 2, wherein generating the contextual content comprises, for each contextual frame of the one or more contextual frames, adjusting one or more image characteristics of the contextual frame based on the corresponding scene position information for the contextual frame.

8. The electronic device of claim 2, wherein the one or more contextual frames comprise all of the frames of the video.

9. The electronic device of claim 2, wherein generating the contextual content comprises:
analyzing the one or more contextual frames and the corresponding scene position information to differentiate portions of each of the one or more contextual frames changing due to movement of a camera recording the video and portions of each of the one or more contextual frames changing due to movement of one or more subjects in the one or more contextual frames; and
generating the contextual content based on a difference between the portions of each of the one or more contextual frames changing due to movement of the camera and the portions of each of the one or more contextual frames changing due to movement of one or more subjects in the one or more contextual frames.

10. The electronic device of claim 1, further comprising a motion tracking system configured to provide motion information about the electronic device, wherein:
the processor is communicably coupled to the motion tracking system; and
the processor is further configured to:
determine the displayed portion of the extended reality environment based on the motion information from the motion tracking system;
in accordance with a determination that at least a portion of the frame is not within the displayed portion of the extended reality environment, present an indicator in the displayed portion of the extended reality environment.

11. The electronic device of claim 10, wherein the indicator provides a direction of the current frame of the video in the extended reality environment with respect to a location of the indicator in the extended reality environment.

12. The electronic device of claim 1, wherein the scene position information is based on movement of the camera during recording of the video.

13. The electronic device of claim 1, wherein the location for the frame in the extended reality environment includes spherical coordinates describing the location of the frame as projected on an interior of a sphere within the extended reality environment.

14. A method for presenting a video of a scene in an extended reality environment, comprising:
generating the extended reality environment;
obtaining a video of a scene, wherein the video includes a plurality of frames, each associated with corresponding scene position information describing an orientation of a camera during capture of the frame relative to a fixed view point;
for each frame of the plurality of frames:
determining a location for the frame in the extended reality environment based on the corresponding scene position information; and
in accordance with a determination that at least a portion of the frame is within a displayed portion of the extended reality environment, presenting the frame at the location in the extended reality environment.

15. The method of claim 14, further comprising generating contextual content associated with the video in the extended reality environment, comprising, for each frame of the plurality of frames:
selecting one or more contextual frames other than the frame;
generating contextual content from the one or more contextual frames; and
in accordance with a determination that at least a portion of the contextual content is within the displayed portion of the extended reality environment, presenting the contextual content in the extended reality environment.

16. The method of claim 15, wherein the contextual content is generated at one or more contextual locations in the extended reality environment selected using the corresponding scene position information from the one or more contextual frames.

17. The method of claim 15, wherein the one or more contextual frames comprise one or more frames preceding the frame.

18. The method claim 15, wherein generating the contextual content further comprises adjusting one or more image characteristics of the one or more contextual frames.

19. The method of claim 15, wherein the one or more contextual frames comprise all of the frames of the video.

20. The method claim 15, wherein generating the contextual content comprises:
analyzing the one or more contextual frames and the corresponding scene position information to differentiate portions of each of the one or more contextual frames changing due to movement of a camera recording the video and portions of each of the one or more contextual frames changing due to movement of one or more subjects in the one or more contextual frames; and
generating the contextual content based on a difference between the portions of each of the one or more contextual frames changing due to movement of the camera and the portions of each of the one or more contextual frames changing due to movement of one or more subjects in the one or more contextual frames.
